(19) United States
(12) Patent Application Publication
(10) Pub. No.: US 2007/0003664 A1
(43) Pub. Date: Jan. 4, 2007

(54) Method for strengthening a protein-containing product and a protein-containing product

(76) Inventor: Jouku Savolainen, Espoo (FI)

Correspondence Address: Jay F Moldovanyi;Fay Sharpe Fagan Minnich & McKee, 1100 Superior Avenue, seventh Floor, Cleveland, OH, 44114-2579, US

(21) Appl. No.: 10/575,156

(22) PCT Filed: Oct. 15, 2004
(86) PCT No.: PCT/FI04/00614

§ 371 Date: Apr. 6, 2006

(30) Foreign Application Priority Data
Oct. 15, 2003 (FI) 20031508
Oct. 15, 2003 (FI) 20031506

(51) Int. Cl. A23C 9/12

(52) U.S. Cl. 426/36

(57) ABSTRACT

The disclosure relates to a method for strengthening the structure of protein-containing products, such as food products, by using modified protein to form disulfide bonds between the proteins in a heat treatment to form a protein network. The disclosure also relates to products prepared with the method.

### FIELD OF THE INVENTION

The present invention relates to a method for strengthening the structure of protein-containing products by using modified protein or fractions made of modified protein. The present invention relates also to a protein-containing product made according to said method.

### BACKGROUND OF THE INVENTION

Many food products, also those of high protein content, need a support material to support their structure in order to achieve a composition acceptable to the consumers and to endure as such until used. The impermanence of the structure will appear as lowering of the viscosity or separation of the liquid phase.

Common protein-containing food products are especially milk-based products, generally low-fat or fat-free products, such as yogurts, sour milks, puddings, spreads, ice creams and drinks. In these the desired structure has been achieved by increasing the protein content to a level high enough, up to 612%, and by heating at a temperature high enough and long enough, or by adding thickening or stabilizing agents, gelatin, modified starch, pectin, carrageen, locust tree powder, guar gum etc.

The gel-forming features of proteins are generally known and they are widely studied. However, all the mechanisms and factors of the gel formation are not completely known. For example different milk and whey proteins have their own, often complicated, roles in the formation of the protein network in gel formation.

According to the state of the art, for example in the production of yoghurt, it is essential to increase the protein content of milk, and according to the methods presently in use, to strengthen the structure by heating. The production is started by increasing the protein content of milk by evaporating, heating at high temperature long enough or by adding milk powder, generally fat-free milk powder, to increase the dry matter of the milk from 8.5-9.0% to 10.5-13.0%. Suitable dry matter content is determined according to the fat content. In this phase other required components, such as fat, sugar and stabilizing and thickening agents are added.

In the next phase of the process the temperature of the pretreated milk is increased to 50-65° C. and it is homogenized in 150-200 bar. This will result in increased number of fat globules which have parts of casein micelles and whey proteins on their surface. Also the number of free casein micelles is increased. Casein particles and whey proteins, both the ones on the surface of the fat globules and the free ones, will take part in the formation of the protein network.

An important phase of the process of manufacture is the denaturation of milk proteins by heating. At the same time the amount of deteriorating bacteria will be decreased in order to maintain the high level of hygiene. The denaturation of the proteins requires generally the temperature of 85° C. or more and will last at least 15-30 minutes.

During the heating as a second phase after the denaturation of the proteins, free sulfhydryl (SH) groups are released especially in whey proteins and in β-lactoglobulins during the denaturation, which will cause an interchange reaction between SH and disulfide (SS) groups. In consequence of this reaction a space network of whey proteins, kappa-casein and all the proteins in the mixture, which contain disulfide bonds in their structure, will be formed, which appears as gelling. The consistency of the network structure mostly depends on the protein content and the effect of the heating. The network structure will strengthen the structure of yoghurt and prevents the whey from separating during storage.

The traditional gel forming by whey proteins is therefore based on the sulfhydryl groups of β-lactoglobulins, one per each β-lactoglobulin monomer. Generally this is the limiting factor in the gel formation since the amount of β-lactoglobulin present is limited. For example the β-lactalbumin of whey, which is also one of the most abundant protein component of whey, does not have any free sulfhydryl groups. Attempts to increase the amount of free sulfhydryl groups may be made by other means, but generally they are not usable for example in food industry. An example of this is Stevenson et al. (J. Argic. Food Chem. 1995, 44: 2825-2828), which discloses a chemical thiolation of bovine β-casein to get a synthetic protein-containing free sulfhydryl groups and numerous disulfide bonds.

Also cysteine can open disulfide bonds as a small compound containing an SH group, but it does not have in itself the ability to strengthen the structure because it lacks the ability to form the strengthening protein network, which requires at least two SH groups. Furthermore, above certain concentration cysteine is under the medicine law in Finland. In Great Britain the highest allowable amount for example for making dough is 70 ppm.

The structure of yoghurt is generally modified at the later phases of manufacture mainly with starter culture and the possible support for the structure it provides, and by stirring and by the intensity of stirring.

Especially when preparing fat-free yoghurt and sour milk it is necessary to increase more the amount of protein in comparison to fat-containing products since the caseine and the whey proteins on the surface of the fat globules are missing.

As a consequence of the heating many side products will be formed which lower the nutritional value of the proteins and may affect disadvantageously when consumed, for example as allergens (Walstra, P. et al. Dairy Technology, Principles of Milk Properties and Processes. Marcel Dekker 1999).

The thickening and stabilizing agents used for strengthening the structure are not the original compounds of milk but originate from different parts of animal carcass, such as gelatin, or plants' parts, such as pectin, karragenan, guar gum etc., and they do not possess substantial nutritional value. Furthermore, health hazard or ethical aspects are related to certain animal-based food additives, such as gelatine, restricting the use thereof.

There is need for a new method for strengthening the structure of food products avoiding the unnecessary long heating of the product at high temperature or adding extra thickening or stabilizing agents.

Methods for modifying or fractionating protein, such as whey protein, are known. One such method includes modifying the structure of the protein by cleaving the sulfur bridges or disulfide bonds between the amino acid chains of proteins.

Generally this is accomplished by sulfonation reaction wherein the proteins are contacted with a reagent forming sulfite ions to sulfonate the proteins. This will start a redox reaction wherein the other sulfur of a protein sulfur bridge will be oxidized into sulfonate and the other one will be reduced into sulfhydryl group. By still adding an oxidizing factor the free sulfhydryl groups will be reoxidized into disulfide bonds, which in turn will continue in the reaction as long as all the sulfhydryl groups are sulfonated or some other factor in the reaction has become limiting.

For example FI101514 and FI107116 disclose methods for the sulfonation and modification of proteins to isolate the proteins. FI101514 discloses a method wherein the structures of whey proteins are modified by sulfonation without a catalyst. The publication does not disclose any specific applications or methods for the isolated proteins.

FI107116 discloses a method for modification of the protein structure by contacting the protein with a sulfite ions forming reagent to sulfonate the protein without a catalyst in sulfitolysis. By lowering the pH of the sulfonated protein into acidic the sulfonate groups will be released from the protein as sulfur dioxide which has been removed from the solution by blowing air. Part of the modified protein precipitates at low pH and part of it will remain soluble. Protein can be recovered either as a mixture of precipitated and soluble protein, total whey protein, or as precipitated and soluble fractions, and they may be exposed to optional after treatment. This method is based on the fact that in the modification of the proteins the sulfitolysis itself is adequate to cause the cleavage of disulfide bonds and the oxidation step is not required to change the conformation of a protein molecule and to precipitate the proteins in acidic environment. Omitting the oxidation step will simplify and speed up the process and improve the profitability.

The precipitate fraction contains α-lactalbumin, bovine serum albumin (BSA) and some β-lactoglobulin. The soluble fraction contains essentially only β-lactoglobulin. Substantially all the proteins are modified and they have improved functional properties. The modified whey proteins and the both fractions have certain favorable targets of applications, such as film forming for the soluble fraction and emulsification and strengthening of the structure for the precipitate fraction. Best one of these three processed products can be chosen case-specifically for suitable application or product. Moreover, the amounts of the proteins in each fraction can be affected by changing the reaction conditions, for example by raising the pH used in the precipitation.

In the method of FI107116 the cleavage of disulfide bonds and the change of conformation of proteins, such as whey and soy proteins, is achieved by sulfitolysis, wherein sulfite ion reacts specifically with one of the sulfurs in disulfide bond and forms an S-sulfonate derivative. The other sulfur will be reduced into sulfhydryl group. It is preferred to use sulfite of alkali metal or earth alkali metal, hydrogen sulfite or metabisulfite or combinations thereof as sulfite. The most useful sulfites in this method are soluble and food grade sodium sulfite, sodium hydrogen sulfite and sodium metabisulfite, but other suitable sulfite compounds may also be used. All of the above mentioned sulfites will form mainly sodium sulfite and sodium hydrogen sulfite in the reaction conditions.

### BRIEF DESCRIPTION OF THE INVENTION

The current invention provides a method for strengthening the structure of a protein-containing product during a heat treatment of said product by forming disulfide bonds between the proteins to form a protein space network, comprising adding modified protein to said product before said heat treatment, which protein is modified by cleaving at least one disulfide bond originally present in said protein to obtain free sulfhydryl groups, and heating said product for less than 15 minutes to cause an interchange reaction by said free sulfhydryl groups, wherein said structure strengthening disulfide bridges will be formed between proteins.

The current invention provides also a protein-containing product comprising a protein space network strengthening the structure of said product, which network is formed by disulfide bonds in a heat treatment between proteins, wherein said protein network is created by adding modified protein to the product before said heat treatment, which protein is modified by cleaving at least one disulfide bond originally present in said protein to obtain free sulfhydryl groups, and said structure-strengthening disulfide bonds are formed in an interchange reaction caused by said free sulfhydryl groups during a heat treatment of less than 15 minutes.

It is an object of the present invention to provide a novel method for strengthening the structure of protein-containing products, generally food products, by using modified protein, preferably whey protein, wherein the protein contains free sulfhydryl (SH) groups as a result of the modification (FIG. 1), which SH groups originate from the disulfide bonds originally present in the protein. As a result of a short heat treatment, such as pasteurization, the free SH groups will cause an interchange reaction wherein disulfide (SS) bonds will be formed and the proteins will form a space network, which supports the structure of the protein-containing product. Thus a long heat treatment at high temperature, such as generally used 85-95° C. for 15-30 minutes or the like, of the traditional methods is avoided (FIG. 2). The heat treatment of the current invention requires 15 minutes or less, preferably 15 seconds-14 minutes, more preferably 1-10 minutes. Suitable temperature is above denaturing or pasteurizing temperature, such as 70-85° C., preferably 70-80° C. Generally 72-75° C. may be used.

It is characteristic of the method and the product of the present invention what is disclosed in the independent claims. Some preferred embodiments of the present invention are disclosed in the dependent claims.

It is an object of the present invention to provide a simple method for strengthening the structure of a food product, preferably a milk containing food product, such as yoghurt, using the nutritionally valuable proteins of milk and without using long-term heat treatment at high temperatures to modify or denature the structure of the proteins, wherein compounds deteriorating the nutritional value of the protein are known to be formed.

“Food product” as used herein refers to any edible product or pre-stage thereof, for consumption by humans or animals. In addition to conventional food products “food product” may also mean for example animal fodder or pet food. Food product may also be a semi-finished product or pre-stage thereof, such as dough.

The idea of present invention is that for example modified and fractionated whey protein prepared for example according to FI107116 may be used for strengthening the structure of proteins by the interchange reaction of SH and SS groups. The modified whey protein and whey protein fractions, which are milk's own compounds, contain free SH groups, which will start the interchange reaction and the acceleration of the speed of the reaction, especially at the pasteurizing temperature. Other types of protein, such as soy protein, may be used as well. Prerequisite for this is that in the protein to be used in the method of the invention there has been originally at least one disulfide bond present, which can be cleaved in the interchange reaction to obtain free SH groups. Such proteins, wherein extra disulfide bonds or extra SH groups are artificially created into a native protein, are not within the scope of the invention.

With the method of the present invention the strengthening of any proteins of any food product, such as milk or milk product or other proteins of edible products containing disulfide bonds, can be accomplished by adding suitable amount of modified protein, for example modified whey protein, and heating for appropriate time, for example at pasteurizing temperature. The pasteurizing temperatures generally used in the art are in the range of 60-80° C., for example 30 minutes at 60° C. or 15 seconds at 72° C., the temperature and the treatment time being interrelated. The selected temperature-time combination depends mainly on the number of the SH groups, the bigger the number the gentler the treatment, as is the case in the present invention (see the table below).

An advantage of the present invention is that the intense and long heat treatment of the food product, which may deteriorate the taste or appearance of the product, can be cut down.

Another advantage of the present invention is that products with stronger structure will be obtained.

Still another advantage of the present invention is that products with better protein content will be obtained.

Still another advantage of the present invention is that the use of extra thickening and stabilizing agents, such as gelatin and karragenan, may be avoided.

Still another advantage of the present invention is that the food products obtained contain functional properties.

Still another advantage of the present invention is that proteins of natural origin are used.

Still another advantage of the present invention is that when the proteins are sulfonated, only a small amount of sulfite forming agent is required.

The following table shows a comparison of the composition and functional properties of the modified whey protein according to the invention and intact whey protein.

| Property | Modified protein | Intact protein |
|---|---|---|
| Modification by sulfitolysis | + | − |
| Degree of modification | 15-30% | 0% |
| Free SH groups/protein molecule | 2-4 | <1 |
| Interchange reaction SH-/S- | + | + |
| S in formation of net structure | | |
| Conditions for interchange | | |
| Temperature | 70-85° C. | 85-95° C. |
| Exposure time | less than 15 min | 15-30 min |
| Rate of interchange | Quick | Slow |
| Formation of emulsion | +++ | + |
| Formation of gel | +++ | + |
| Digestibility/hydrolysability | +++ | + |
| of protein | | |

Next the present invention will be described in detail with examples related to production of food products and which disclose some embodiments of the invention, but which should not be considered as limiting the scope of the invention. In the description references will be made to the following figures and descriptions.

### BRIEF DESCRIPTION OF THE DRAWINGS

FIG. 1 shows the modification reaction.

FIG. 2 shows the interchange reaction and interchange modification, wherein in the interchange reaction the protein P₁ is interchange modified and modified protein P will form the first phase of the protein network with original protein P₁.

FIG. 3 shows the oxidation of sulfhydryl groups to disulfide groups, whereupon the amount of SH groups decreases and the amount of bonds increases and the structure of the network strengthens.

FIG. 4 shows the formation of the Amadori compound.

FIG. 5 shows the formation of lysinoalanine from lysine and dehydroalanine either as free or as part of a peptide; dehydroalanine forms from cysteine, cystine and serine.

FIG. 6 shows the neutralization of acryl amide, whereupon an acryloderivative of cystein is formed, having no acryl double bond.

### DETAILED DESCRIPTION OF THE INVENTION

A preferred protein to be used in the method and the product of the present invention is whey protein, such as bovine whey protein, since it has very high biological value. The biological value of a protein is a ratio of the amount of nitrogen used for tissue formation to the amount of nitrogen absorbed from food thus describing the quality of the protein.

To determine the biological value the egg protein is generally used as reference and it is valued as 100. Compared to this whey protein is 104, bovine milk is 91, casein is 77 and soy protein is 74.

Modified whey protein equals to native whey protein by nourishing aspect, but the nutritional values are increased by better digestibility in the stomach. The main proteins of whey are β-lactoglobulin, β-lactalbumin, serum albumin and immunoglobulins. β-lactoglobulin of the native i.e. non-modified whey protein, composing about half of the total whey protein, is not virtually digested or hydrolyzed at all in the stomach and it passes straight to the small intestine. This is an important factor associated with children's milk allergy.

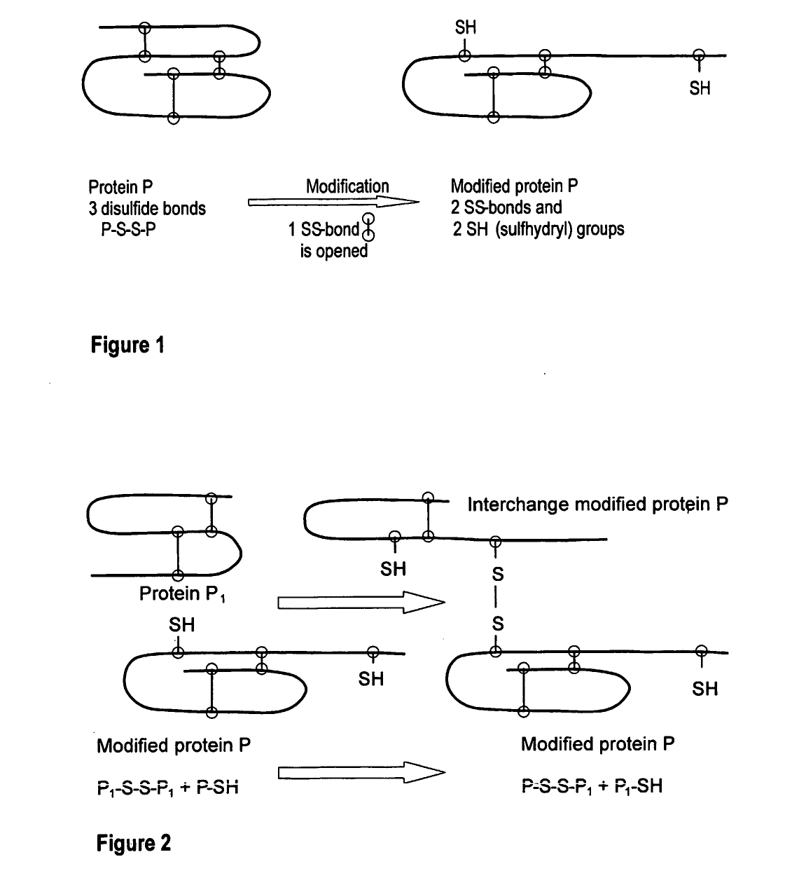

The modified protein or fractions thereof contain sulfhydryl groups causing the interchange reaction and thus resulting to interchange modification. The result of the interchange modification is the strengthening of the structure of a protein-containing product as the proteins containing disulfide bonds form a space network, as can be seen in FIG. 2. There is shown the interchange modification of protein P₁ in the interchange reaction and the first phase of the formation of the network. The modified protein P together with the original protein P₁ forms the first phase of the protein network. The reaction continues until the network is formed under these conditions. The amount of SH groups remains the same unless it is desired to decrease the amount of SH groups by oxidizing them to disulfide bonds. By controlling the oxidization of the formulation of desired type of protein network can be controlled.

The free sulfhydryl groups of modified protein and fractions thereof provide several types of protective effects in food products and for example in pet foods. Said proteins act as antioxidants and as a result of the interchange the protein toxins of plants or microbes containing disulfide bonds will loose their toxicity. Further the modified proteins prevent the formation of the compounds formed at the beginning of the Maillard reaction, such as Amadori compound, and the formation of lysinoalanine and neutralize e.g. acryl amide and other acryl derivatives (FIGS. 2, 3, 4, 5 and 6).

In Maillard reaction the reducing sugars, such as glucose, fructose, maltose and lactose, react with the amino groups in proteins thus decreasing the biological value of the protein. As a result of the Maillard reaction several products are formed which affect negatively to the taste and appearance of the food product or act as allergens.

In the interchange reaction the free SH groups of the protein, preferably whey protein, will cause the cleavage of SS bond in whey protein or any other protein when heated and also the formation of a new SS group together with a free SH group. As the reaction goes on for a certain time with suitable amount of SH groups it will result in protein structure with a certain degree of strength. The forming of the network structure involves whey proteins and caseins both as free in a solution and on the surface of fat globules, wherein the proteins as protein network act as emulsifiers.

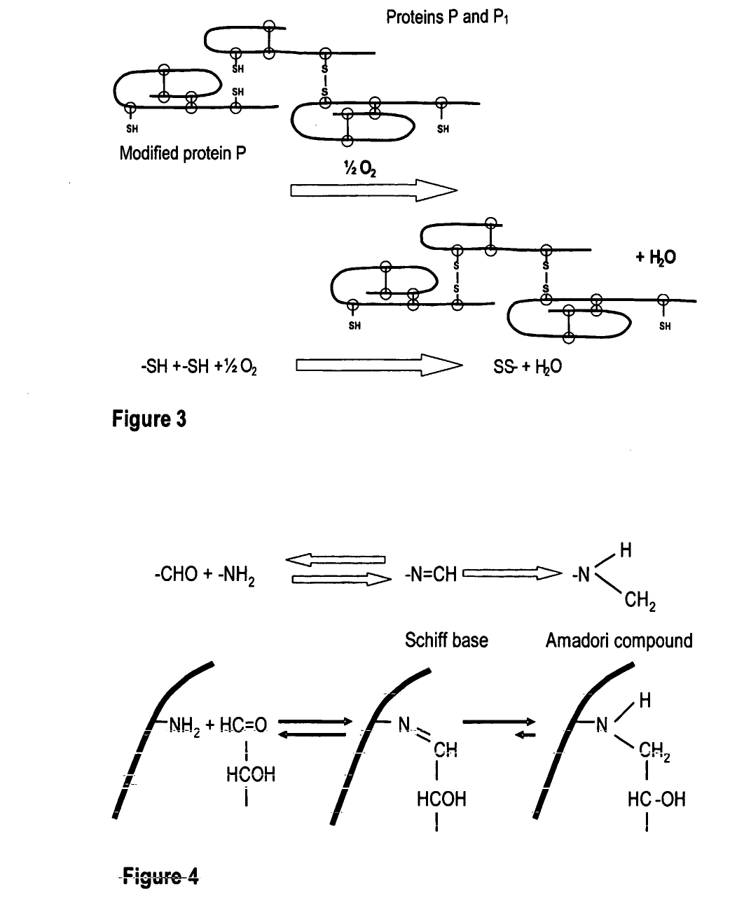

In the interchange reaction the amount of SH groups does not decrease. The amount of SH groups can be decreased by oxidizing them by e.g. air oxygen to disulfide groups 2 SH+½O₂→S—S+H₂O which will further strengthen the structure of the product (FIG. 3).

The functional and other properties of the end products may be affected by the degree of the modification i.e. by the ratio of the amount of cleaved disulfide bonds to the disulfide bonds in the protein. According to the purpose and aim of the use a suitable amount of free SH groups may be left, since SH groups act as antioxidants, neutralize toxic protein compounds from plants and microbes by interchange modification and for example acryl amide by reacting with the double bond thereon (Friedman, M., J. Agric. Food Chem. 42 (1994) 3-20) (FIG. 6). In addition the free SH groups prevent chemical and enzymatic browning and they also conjugate, detoxify and neutralize xenobiotics e.g. aflatoxin produced by mold. They also bind nitrite, chelate oxidizing Cu²⁺ and Fe²⁺ ions and toxic As³⁺, Cd²⁺, Co³⁺, Hg²⁺, Pb²⁺ and Se²⁺ ions. With a protein having free SH groups it is possible to turn food product into a functional or health promoting product, which was discovered in the present invention. The free SH groups have also therapeutic properties, such as healing of the damages in the mucous membrane of digestive tract caused by alcohol (Loguercio C. et al. Gut 34 (1993) 161-165).

The most important factor affecting the degree of modification in the sulfitolysis is the amount of sulfite per amount of protein. Surprisingly it was discovered that the amount of sulfite required is lower than for example FI101514 or FI107116 discloses. According to the present invention the amount of added sulfite as sodium metabisulfite is about 0.01-0.06% (w/v) when the amount of protein in the solution is 10-11% (w/v).

The amount of free sulfhydryl groups added to the product to be produced is for example 0.5-60 μmol/g calculated from the total protein of the product, preferably about 5-20 μmol/g, before the interchange modification. In the experiments conducted it was discovered that when there were at least certain amount of free SH groups present, it can be observed in the end product as a metallic aftertaste. The tasting limit of cysteine SH groups as aftertaste was 30 ppm i.e. 25 μmol/g. None of the tasters did taste this amount as aftertaste in fat-free milk, unflavored yoghurt or low-fat sour milk. In fat-free yoghurt the SH groups from modified whey protein were not tasted even at the concentration of 30 μmol/g protein. However when after-treating the product later on, such as during sterilization, side products reacting with free SH groups and decreasing their amount may form and this may decrease the final threshold for tasteability of SH groups. This can be taken into account already when planning the amount of free SH groups in the basic product.

A product prepared with the method of present invention can be distinguished from a product prepared with traditional heating method based on the physical properties of the products. For example when comparing said products the average amount of SH groups present in modified and fractionated whey proteins is significantly higher than in traditional products, about 2-4 SH groups per protein molecule vs. less than 1 SH group per protein molecule, respectively. These properties can be studied with methods well known in the art, such as Ellman's reagent (Beveridge, T. J. et al., J. Food Sci. 39 (1974) 49-51) and electrophoresis (Laemmli, U. K. Nature 227 (1970) 680-685). Also, the amount of side products, such as Amadori compound and lysinoalanine, in the product according to the invention is significantly lower than in traditional products. These compounds may also be determined using methods known in the art, for example with liquid chromatography (Chevalier, F. et al. Nahrung/Food 46 (2002) 58-63 and Wood-Rethwill, J. C. and Warthensen, J. J. J. Food Sci. 45 (1980) 1637-1640)

The manufacturing of yoghurt by the traditional method from fat-free milk (about 0.05% fat) generally requires the concentration of milk by evaporating water to increase the dry substance by 2-3 percentage unit i.e. the same amount given by addition of 2% (about 20 g/l) fat-free milk powder.

According to one preferred embodiment of the present invention the same effect is achieved by adding mixture of modified whey protein and whey protein powder to fat-free milk in the amount of 0.8-1.6 percentage unit (8-16 g/l) as protein in the ratio of 10-20% of modified whey protein and 80-90% of 75% whey protein concentrate or equivalent amount or part of soy protein powder or other protein product. When preparing low-fat yoghurt with vegetable oil supplement, the oil (for example 0.5-1.0%) may be added in this phase. When strengthening the structure of low-fat milk a smaller amount of protein is required, about 0.6-1.0 percentage unit.

The composition of modified whey protein is equal to unmodified whey protein. In the modification part of the disulfide bonds are cleaved and they have formed free SH groups. In modified whey protein the amount of free SH groups is generally about 65-85% μmol/g protein, preferably about 75 μmol/g protein, as in the examples below.

The mixture may be mildly homogenized for example at 50° C. and in 50 bar to ensure the smooth distribution of components. When 0.5-1.5% of fat or oil is added for health reasons, for example rape seed oil, olive oil, sunflower oil, linseed oil or other functional health product, the homogenization may be done at 55-60° C. and in 100-200 bar to emulsify the oil to equal size, small enough, less than 1 μm, globules or droplets.

After the homogenization the milk is pasteurized for example at 72-80° C. for 15 seconds to 10 minutes to accomplish the interchange reaction. Also longer treatment times and higher temperatures may be used in specific cases, for example when products having certain additional properties are desired. In such cases the treating times and temperatures are still substantially gentler when compared to traditional methods.

After the heat treatment the milk is cooled down to the inoculation and fermentation temperature 42-45° C. The fermentation will take 3-6 hours and depends on the temperature and the bacteria used as the inoculum. The fermentation of the yoghurt is stopped at about pH 4.3-4.6, generally at pH 4.5, which will be lowered further during the cooling and storage. The structure/gel of the yoghurt is strongest at pH 4.65 as the viscosity is highest.

After the fermentation the yoghurt is cooled down below 20° C. and mixed carefully. The yoghurt is packed into beakers or cartons and it is cooled down to the storage temperature 6-8° C.

According to one embodiment of the present invention the making of fat-free sour milk from fat-free milk is possible by the method described above. The structure of fat-free sour milk usually remains weak and whey will easily separate. By strengthening the structure by using interchange modification with additional whey protein, sour milk with stable structure and without separation of whey will be obtained. Healthy unsaturated oils, such as rapeseed, linseed or Camelina oils, may be added and they will be emulsified by interchange of modified and intact whey protein as a result of the homogenization. The sour milk's own starter culture will work at 20° C. and it needs time over night or 12-14 hours for fermentation. On the surface of the sour milk a conventional white and velvety Geotrichum white mold growth originated from the sour milk's starter culture will be developed.

Generally the basic substance of the preparation of puddings is milk wherein sugar and flavoring agents are added as well as protein for thickening, gelatin or whey protein, and additional pectin, starch/modified starch or karragenan. According to still one preferred embodiment of the invention by using interchange modified whey protein in the preparation of puddings a nutritionally valuable protein addition is obtained, which acts as the strengthener of the structure by moderate heating, and the generally used thickening and stabilizing agents, such as gelatin or karragenan, may be abandoned.

Protein-containing spreads may be prepared on milk base, such as soured milk, where fat, such as margarine, whey protein, spices and thickening agents are added. According to still one preferred embodiment of the invention with the addition of modified whey protein the structure of the spread can be strengthened and a nutritional protein addition is obtained. The amount of other thickening agents, such as herein generally used karragenan and locust powder, can be diminished or omitted.

In the preparation of dough in the art cysteine is generally used to speed up the kneading and to decrease the amount of energy needed for mixing. By kneading or efficient mixing of the dough the disulfide bonds of the wheat flour gluten are cleaved mechanically. The addition of cysteine helps the cleavage of the disulfide bonds by interchange reaction and the softening and loosening of the dough, which is important for the final structure of the bread.

“Dough” as used herein refers to any dough used in baking or preparation of food products known in the art, for example for preparing bread, pastry or the like. In the preparation of dough preferably wheat flour is used as the structure former since wheat has enough gluten to maintain the structure. Other flours, such as rye, barley or oat flours may be additionally used for nutritional or flavor reasons.

The use of cysteine is generally restricted to the amount of 70 ppm. The recommended level for the use of cysteine is 35-70 ppm depending on the hardness of wheat/flours. Overdosage will produce sticky dough which is hard to handle. The nutritional value of the cysteine used is low.

The strengthening of the dough structure with modified whey protein works out fine. There is no danger of overdose of SH groups and the added protein has got also nutritional values. Whey protein powder with 75% protein content has been used in dough as supplements of 2-4% of the amount of flour. The results obtained are diverse depending on the treatment. Modified and intact whey protein mixture added as supplements of 1.5% of the amount of flour calculated as protein and it has positive effect on the properties of the dough.

The kneading of dough will cleave the disulfide bonds of gluten, the protein of wheat. The addition of modified whey protein or modified and intact whey protein mixture will facilitate kneading and strengthen the structure of dough.

### EXAMPLES

The following examples and the tests related describe the invention disclosed above applied to several manufacturing processes of food products by using the modified whey protein, wherein the amount of free SH groups is about 75 μmol/g protein. However, it is emphasized that any other suitable non-synthetic protein may also be used.

Total amount of SH groups to be added into a product can be controlled by the amount of modified protein with known SH group content. The amount of SH groups in intact whey protein is on average 20 μmol/g protein, which will be available for interchange after heating at e.g. 75° C. for 10 minutes. In modified whey protein and whey protein fractions the SH groups are available already when added into the product to be prepared e.g. into yoghurt milk without any heat treatment.

The modified whey protein or the mixture of modified and intact whey protein to increase the protein content is used in the preparation processes of food products to achieve, by using the interchange modification, the strengthening of protein structure by forming a space network. With the same principle it works also as emulsifier, because of the modification it is digested better in the digestive tract compared to unmodified whey protein and by the nutritional value it is one of the best proteins available.

### Example 1

Three different test samples of fat-free yoghurt with different compositions and one reference sample were prepared. All the samples were treated the same way.

The reference sample contained 980 ml fat-free milk and 20.0 g fat-free milk powder. The test samples contained 920 ml fat-free milk and 80 ml protein mixture. The test samples differed from each other by the amount of modified whey protein.

Test sample 1 contained 27 ml modified whey protein concentrate with protein content of 12% and 53 ml unmodified whey protein concentrate with protein content of 12%. 80 ml of protein mixture contained 9.6 g protein.

Test sample 2 contained 20% modified whey protein concentrate i.e. 16 ml and 64 ml unmodified whey protein concentrate.

Test sample 3 contained 16 ml modified whey protein concentrate and 64 ml unmodified whey protein concentrate. This protein mixture was heated/pasteurized at 78° C. for 5 minutes.

The reference and test samples were pasteurized at 78° C. for 1-2 minutes and cooled down to 45° C. The starter culture was added in this temperature and as culture 0.30 g/l of yoghurt culture was used (Yo-Mix VM 1-34; Danisco Cultor). The fermentation lasted 7 hours at 45° C. whereupon the samples reached pH 4.4-4.5. The samples were cooled to 5-7° C., stirred, packed into beakers and kept in the refrigerator for 1 day before the assays. The samples were assayed for viscosity and the appearance, smell, structure, taste and mouth feel were sensory-evaluated.

The viscosity of the samples was measured with viscometer Haage Visco-Tester 7R (spindle R4, 50 rpm) 1-2 days after the preparation.

The viscosities of the samples were:

| Reference sample | Test sample 1 | Test sample 2 | Test sample 3 |
|---|---|---|---|
| 3300 mPa | 3210 mPa | 3130 mPa | 2280 mPa |

Sensory evaluation; scale 1-5; 5 evaluators

| | | | | | Mouth | |
|---|---|---|---|---|---|---|
| Sample | Appearance | Smell | Structure | Taste | feel | Average |
| Reference | 1.8 | 4.1 | 2.4 | 3.6 | 2.1 | 2.80 |
| Sample 1 | 2.5 | 4.1 | 2.9 | 3.1 | 2.8 | 3.08 |
| Sample 2 | 4.5 | 3.8 | 2.4 | 3.0 | 2.2 | 3.18 |
| Sample 3 | 4.2 | 3.9 | 4.3 | 3.6 | 4.0 | 4.00 |

Verbal Description:
Reference sample: grainy, thick, mild, sour, no tangy aftertaste
Test sample 1: grainy, loose, sour, astringent aftertaste
Test sample 2: grainy, loose, sour, astringent aftertaste
Test sample 3: homogenous, thinnest, sour, slightly astringent aftertaste

### Example 2

Two test samples of fat-free yoghurt and one reference sample were prepared. All the samples were treated the same way.

The reference sample contained 980 ml fat-free milk and 20.0 g fat-free milk powder. The test samples contained 920 ml fat-free milk and 80 ml protein mixture. 80 ml of protein mixture contained 9.6 g protein. The same amount of modified whey protein was added to both test samples. To test sample 1 an amount of dehydroascorbic acid was added to oxidize the free SH groups to disulfide bonds.

The 80 ml of protein mixture added to test samples contained 15% i.e. 12 ml of modified whey protein concentrate and 85% i.e. 68 ml of unmodified whey protein concentrate. The protein content of the both concentrates was 12%.

The reference and test samples were pasteurized at 80° C. for 3 minutes and cooled down to 42° C. 50 mg/l of DHAH (dehydroascorbic acid), either purchased (Sigma) or prepared according to instructions (Tolbert, B. M. & Ward, J. B. 1982 Adv. Chem. Ser. No. 200, p. 101-123), was added into test sample 1, mixed for 30 minutes at 42° C. and reacted before adding the starter culture.

As a starter culture Yo-Mix VM 1-34 (Danisco Cultor) was used. The culture was activated by adding 20 g of melted culture to 200 ml of milk pasteurized at 78° C. for 3 minutes and cooled down to 42° C., and by incubating for two hours. 3.0 ml of activate culture was added to 1 liter of yoghurt milk.

The milk was soured at 42° C. until pH was lowered to 4.3. The time needed for souring was 4.5 hours. All the samples reached the required acidity almost at the same time i.e. the fermentation took the same time in every sample.

The samples were cooled down to 4° C., conditioned by stirring into homogeneity, packed into beakers and stored at the refrigerator. The viscosity of the samples was measured 1 day after preparing with Haage Visco-Tester 7R (spindle R4 50 rpm).

The viscosities of the samples were:

| Reference sample | Test sample 1 | Test sample 2 |
|---|---|---|
| 3300 mPa | 2300 mPa | 2300 mPa |

The taste of the test samples was sour with no tangy metallic aftertaste.

### Example 3

Three test samples of fat-free yoghurt and one reference sample were prepared. The reference sample contained 980 ml fat-free milk and 20.0 g fat-free milk powder. The compositions of the test samples were all the same, 920 ml fat-free milk and 80 ml protein mixture, wherein the proportion of modified whey protein was 15% i.e. 12 ml of protein mixture containing 12% protein. All the samples went through different heating treatments.

The reference sample was pasteurized at 90° C. for 15 minutes, test sample 1 at 80° C. for 5 minutes, test sample 2 at 80° C. for 10 minutes and test sample 3 at 80° C. for 15 minutes. All the samples were cooled down to 42-45° C.

The starter culture was added to yoghurt milk at 42-45° C. As culture unflavoured yoghurt prepared by Valio Oy was used. It was added 4% i.e. 40 g/l. Yoghurt was fermented until pH 4.6. It took 4-5 hours.

The samples were cooled down to 4° C., conditioned by stirring into homogeneity and packed into 2 dl beakers. The beakers were stored at refrigerator at 4° C.

The fermentation time until pH 4.6 was:

| Reference sample | Test sample 1 | Test sample 2 | Test sample 3 |
|---|---|---|---|
| 5 h | 4 h-20 min | 4 h-15 min | 4 h-30 min |

The viscosities of the samples were measured with Haage Visco-Tester 7R (spindle R4 50 rpm) and they were sensory-evaluated 1 day after preparing.

The viscosities of the samples were:

| Reference sample | Test sample 1 | Test sample 2 | Test sample 3 |
|---|---|---|---|
| 3900 mPa | 3600 mPa | 3000 mPa | 3800 mPa |

Sensory evaluation; scale 1-5; 5 evaluators

| | | | | | Mouth | |
|---|---|---|---|---|---|---|
| Sample | Appearance | Smell | Structure | Taste | feel | Average |
| Reference | 4.9 | 4.1 | 4.1 | 3.6 | 4.0 | 4.2 |
| Sample 1 | 4.8 | 4.2 | 4.1 | 4.0 | 3.9 | 4.2 |
| Sample 2 | 4.8 | 4.1 | 4.2 | 4.3 | 5.0 | 4.5 |
| Sample 3 | 4.6 | 4.1 | 3.8 | 4.2 | 4.2 | 4.2 |

Verbal Description:
Reference sample: smooth, sour, sour milk like, not fresh, stretchy
Test sample 1: smooth, constant, strongly sour, sour milk like, fresh, soft, tangy aftertaste
Test sample 2: smooth, constant, strongly sour, sour milk like, fresh, soft
Test sample 3: smooth, constant, sour, sour milk like, fresh, soft

### Example 4

Two test samples of fat-free yoghurt and one reference sample were prepared. The reference sample contained 980 ml fat-free milk and 20.0 g fat-free milk powder. The compositions of the test samples differed only slightly. Test sample 1 contained 11 g/l lyophilized protein mixture, wherein the proportion of the modified protein was 15% of the total protein 9.6 g. Test sample 2 contained the same amount of protein mixture in one liter, but it was first dissolved to 80 ml of water and added to milk q.s. one liter.

The reference sample was pasteurized at 90° C. for 15 minutes. Test samples 1 and 2 were pasteurized at 80° C. for 15 minutes. All the samples were cooled down to 42-45° C.

As the inoculum unflavored yoghurt manufactured by Valio Oy was used. It was added to 4% i.e. 40 g/l of cooled (42-45° C.) yoghurt milk and fermented until pH 4.5. The fermentation time was about 4 hours.

The samples were cooled down to 4° C., conditioned by mixing into homogeneity and packed into 2 dl beakers. The beakers were stored at refrigerator at 4° C.

Parts of test samples 1 and 2 were run through homogenizer without pressure. The viscosities of the original and homogenized samples (test samples 1/p and 2/p) were measured with Haage Visco-Tester 7R (spindle R4 50 rpm) and they were sensory-evaluated 1 day after preparing.

The viscosities of the samples were:

| Reference | | | Test sample | Test sample |
|---|---|---|---|---|
| sample | Test sample 1 | Test sample 2 | 1/p | 2/p |
| 4400 mPa | 3900 mPa | 3700 mPa | 1150 mPa | 1900 mPa |

Sensory evaluation; scale 1-5; 5 evaluators

| | | | | | Mouth | |
|---|---|---|---|---|---|---|
| Sample | Appearance | Smell | Structure | Taste | feel | Average |
| Reference | 4.4 | 4.4 | 3.9 | 4.2 | 3.9 | 4.2 |
| Sample 1 | 4.8 | 4.4 | 4.31 | 4.1 | 4.2 | 4.4 |
| Sample 2 | 4.8 | 4.2 | 4.4 | 4.2 | 4.2 | 4.4 |
| Sample 1/p | 5.0 | 4.4 | 3.6 | 3.6 | 2.8 | 3.9 |
| Sample 2/p | 5.0 | 4.2 | 4.4 | 4.4 | 4.1 | 4.4 |

There were no significant differences between the thicknesses of the structures of test samples. The test samples were actually considered to be thicker than the reference yoghurt. The structure was similar in each sample, slightly stretchy and thick.

The structure of test sample 1/p was slightly watery and a strange flavor was observed. The test sample 2/p was considered as suitable by is structure, the mouth feel was yoghurt-like soft and the taste was fresh. As a summary of the evaluation this sample was the best of the series.

### Example 5

Three test samples of fat-free sour milk and one reference sample were prepared. The reference sample contained 980 ml fat-free milk and 20.0 g fat-free milk powder. The compositions of the test samples were all the same, 920 ml fat-free milk and 80 ml protein mixture, wherein the proportion of modified whey protein was 15% i.e. 12 ml of protein mixture containing 12% protein. The rest 85% was unmodified whey protein concentrate/retentate.

All the samples were pasteurized at 78° C. for 1-2 minutes. After the pasteurization DHAH (dehydroascorbic acid) wa added to test samples 1 and 2. The test sample 1 was cooled down to 42° C. 25 mg/litre DHAH was added and the temperature was maintained for 30 minutes. The test sample 2 was cooled down to 35° C. 50 mg/litre DHAH was added and the temperature was maintained for 30 minutes. Finally all the samples were cooled down to 20° C.

The starter culture was added to the milk, which was fermented by the unflavoured sour milk containing 1% fat, prepared by Valio Oy. The amount of the culture was 5% i.e. 50 g/l. The milk and culture were mixed well and the mixture was packed to 2 dl beakers and fermented overnight at 20° C. After fermentation the sour milk was placed to refrigerator at 4° C.

Sensory evaluation; scale 1-5; 5 evaluators

| | | | | | Mouth | |
|---|---|---|---|---|---|---|
| Sample | Appearance | Smell | Structure | Taste | feel | Average |
| Reference | 4.0 | 5.0 | 3.0 | 4.2 | 4.2 | 4.1 |
| Sample 1 | 4.0 | 5.0 | 3.0 | 4.2 | 4.3 | 4.1 |
| Sample 2 | 4.0 | 5.0 | 4.0 | 4.4 | 4.5 | 4.4 |
| Sample 3 | 4.0 | 5.0 | 4.5 | 4.3 | 4.5 | 4.5 |

On the surface of every beaker there was slightly unevenly distributed Geotrichum growth. The structure of all the samples was assertive and it did not fall from a beaker turned upside down.
Reference sample: mat surface, grainy, loose, good taste
Test sample 1: mat surface, grainy, loose, good taste
Test sample 2: glossy surface, a hole made with spoon holds quite well, good taste
Test sample 3: glossy surface, best of the samples, chipable, a hole holds well, good taste

### Example 6

Two test samples of fat-free yoghurt were prepared. The amount of protein added was 10 g of protein per liter in sample A and 13 g of protein per liter in sample B. The protein mixture was prepared to contain 10 g protein in 80 ml. 15% of it (12 ml), which contained 1.5 g protein, was modified whey protein (patch P75) and 85% (68 ml), which contained 8.5 g protein, was whey protein concentrate (from company Juustokaira Oy, Kuusamo, Finland). A solution prepared with abovementioned proportions was lyophilized into powder. As 10 g protein addition 12 g of said powder was required.

12 g/l of protein mixture powder was weight out into sample A and 15.6 g/l into sample B. The protein mixture powder was carefully mixed with fat-free milk into one liter. The powder was mixed and dissolved well into room temperature milk. After this the test samples were pasteurized at 80° C. for 15 minutes and cooled down to 43° C.

As an inoculum 4% of unflavored yoghurt was used (0.5 liter carton, Valio Oy Tampere). Yoghurt was fermented at 43° C. After 4.5 hours the pH of the samples had reached 4.6 and the fermentation was finished. The samples were cooled down to 20° C., conditioned by mixing and placed into refrigerator.

The SH groups were determined from the test samples with Ellman reagent as μmol/g protein.

| | Test sample SH μmol/g protein | |
|---|---|---|
| | A | B |
| Fat-free milk + protein mixture | 10.3 | 11.4 |
| After pasteurization | 13.9 | 14.5 |

The viscosities of the test samples were determined one day after the preparation at 10° C. with Brookfield DV1 Viscometer (spindle 3, 12 rpm). The viscosities of the samples were:

Test sample

| | A | B |
|---|---|---|
| mPas | 8000 | 8600 |

According to the sensory evaluations the samples were almost equal: the structure was constant and thick and the taste was velvety soft.

### Example 7

Three test samples of fat-free yoghurt were prepared. The amount of protein added was 10 g of protein per liter in sample A, 12.5 g of protein per liter in sample B and 15.0 g of protein per liter in sample C. The protein mixture was prepared by mixing lyophilized whey protein powder, protein content 75% (from company Juustokaira Oy, Kuusamo, Finland), and modified whey protein powder (patch P75) to have the ratio of protein amounts 85% whey protein powder and 15% modified whey protein powder. 13 g of the mixture was required for 10 g of protein.

13.0 g/l of protein mixture powder was weight out into sample A, 16.2 into sample B and 16.2 g/l into sample C. The protein mixture powder was carefully mixed with fat-free milk into one liter. The powder was mixed and dissolved well into milk. After this the test samples were pasteurized at 80° C. for 15 minutes and cooled down to 43° C.

As inoculum 4% of unflavored yoghurt was used (0.5 liter carton, Valio Oy Tampere). Yoghurt was fermented at 43° C. for 4 hours, after which the pH of the samples had reached 4.6. The samples were cooled down to 20° C., conditioned by stirring and placed into refrigerator.

The SH groups were determined from the test samples with Eliman reagent as μmol/g protein.

| | Test sample SH μmol/g protein | | |
|---|---|---|---|
| | A | B | C |
| Fat-free milk + protein mixture | 12.7 | 13.4 | 14.0 |
| After pasteurization | 14.8 | 15.5 | 18.6 |

The viscosities of the test samples were determined one day after the preparation at 10° C. with Brookfield DV1 Viscometer (spindle 3, 12 rpm). The viscosities of the samples were:

| | Test sample | | |
|---|---|---|---|
| | A | B | C |
| mPas | 3700 | 3800 | 4000 |

All the samples had constant and firm structure and the taste was pleasingly fresh and velvety soft.

### Example 8

Three test samples of fat-free mixture yoghurt were prepared. The protein addition of sample A contained 12.5 g/l whey protein, the protein addition of sample B contained whey and soy proteins together 12.5 g/l, of which 10% was soy protein, and the protein addition of sample C contained whey and soy proteins together 12.5 g/l, of which 20% was soy protein. To 12.5 g protein an addition 14.7 g/l of whey protein mixture powder was weighed out. This was the same lyophilized whey protein mixture as in example 6.

10% protein addition contains 1.25 g protein. For this amount of protein 1.8 g of soy protein (DANPRO S-900 TS, Central Soya) was needed.

14.7 g/l of lyophilized whey protein mixture powder was weight out into sample A, 13.2 g/l of the same whey protein into sample B and 1.8 g/l of soy protein powder into sample C. The protein mixture powders were carefully mixed together and added to fat-free milk into one liter. The powder was mixed and dissolved well into milk. After this the test samples were pasteurized at 80° C. for 15 minutes and cooled down to 44° C.

As an inoculum 4% of unflavored yoghurt was used (0.5 liter carton, Valio Oy Tampere). Yoghurt was fermented at 43° C. for 4.5 hours, after which the pHs of the samples were 4.55-4.60. The samples were cooled down to 20° C., conditioned by stirring and placed into refrigerator.

The SH groups were determined from the test samples with Ellman reagent as μmol/g protein.

| | Test sample SH μmol/g protein | | |
|---|---|---|---|
| | A | B | C |
| Fat-free milk + protein mixture | 15.2 | 15.0 | 14.8 |
| After pasteurization | 17.3 | 17.2 | 15.3 |

The viscosities of the test samples were determined one day after the preparation at 10° C. with Brookfield DV1 Viscometer (spindle 3, 12 rpm). The viscosities of the samples were:

| | Test sample | | |
|---|---|---|---|
| | A | B | C |
| mPas | 9400 | 9000 | 8500 |

Sample A: constant and firm structure, pleasant taste, fresh and soft.
Samples B & C: constant and firm structure, mild soy taste, but not disturbingly strong

### Example 9

A reference sample and three test samples of fat-free yoghurt were prepared. The protein addition in the reference sample was gelatin. The protein addition in test sample 1 was 10 g/l and 12.5 g/l in test samples 2 and 3. In samples 1 and 2 the protein addition used was the lyophilized-protein-mixture of example 6 and in sample 3 the mixture of modified whey protein powder and whey protein concentrate of example 7.

12.0 g/l of lyophilized protein mixture powder was weight out into sample 1 and 14.7 into sample B. Into sample 3 16.2 g/l of whey protein mixture powder was weighed out. Into the reference sample 4 g/l of gelatin (Extrago) was weighed out. The protein mixture powders were carefully mixed with fat-free milk into one liter. The protein mixture added to sample 1 and 2-dissolved quite well into cold milk. The protein mixture added to sample 3 dissolved well into warmed-up (20-30° C.) milk. The gelatin of the reference sample was mixed with mill at temperature over 50° C. After this the samples were pasteurized at 80° C. for 15 minutes and cooled down to 42° C.

As an inoculum 5 g/l of yoghurt culture Yo-Mix VM 1-30 (Danisco Cultor) was used. Yoghurt was fermented at 42° C. and it took 3 hours 30 minutes for the reference sample to reach pH 4.5 and 3 hours 50 minutes for the test samples, after which the fermentation was finished. The samples were cooled down to 20° C., conditioned by stirring and placed into refrigerator.

The pH and the viscosities of the samples were determined two days after the preparation and the samples were sensory evaluated. The viscosity was measured with Bohlin Visco (V) 88 o 30 system 3 equipment at speed 1.

| Sample | pH | Viscosity mPas |
|---|---|---|
| Reference sample | 4.32 | 1413 |
| Test sample 1 | 4.33 | 1467 |
| Test sample 2 | 4.36 | 1635 |
| Test sample 3 | 4.36 | 1547 |

Sensory Evaluation
Reference sample: no whey at the surface, smooth, thick structure
Test sample 1: no whey at the surface, thicker than the reference, smooth, no strange flavor
Test sample 2: no whey at the surface, thick structure, flaky, no strange flavor
Test sample 3: no whey at the surface, thick structure, flaky, no strange flavor

### Example 10

Three test samples and a reference sample of fat-free yoghurt were prepared. The protein addition in the reference sample was fat-free milk powder and in the test samples Actiwhey-modified whey protein powder (VM4; protein content 75%) and whey protein powder 35%.

All protein powders were carefully mixed with fat-free milk into one liter. All proteins dissolved well into milk. The addition to the reference sample was fat-free milk powder 20.0 g/l, to the test sample 1 whey protein powder 35% 18.0 g/l and Actiwhey-modified protein powder (75%) 2.0 g/l, to the test sample 2 whey protein powder 35% 18.0 g/l and Actiwhey-modified protein powder (75%) 3.0 g/l and to the test sample 3 whey protein powder 35% 18.0 g/l and Actiwhey-modified whey protein powder (75%) 4.0 g/l.

After dissolving all samples were pasteurized at 80° C. for 15 minutes and cooled down to 43° C. As an inoculum 4% of unflavoured yoghurt (0.5 liter carton, Valio Oy Tampere) was used. Yoghurt was fermented at 43° C. for 4.5 hours, after which the pHs of the samples were 4.5. The samples were cooled down to 20° C., conditioned by stirring and placed into refrigerator.

The viscosity and the amount of SH groups of the samples were determined one day after preparation. The viscosity was determined at 10° C. with Brookfield DV 1 Viscometer (spindle 3, 12 rpm). The SH groups were determined with Ellman reagent as μmol/l. Sensory evaluation was performed on appearance and structure, smell and taste.

Viscosity and SH Groups of All Samples:

| Sample | Viscosity mPas | SH groups μmol/l |
|---|---|---|
| Reference | 11800 | 685 |
| Sample 1 | 12000 | 930 |
| Sample 2 | 12180 | 970 |
| Sample 3 | 12640 | 1015 |

Sensory Evaluation
Appearance and Structure:
All samples: thick and uniform structure
   Smell:
All samples: fresh sour smell and flavour
   Taste
Test samples: velvety soft taste
Reference sample: sourer taste and mouth feel than other samples

### Example 11

Dough was made of wheat flour containing modified whey protein and a similar reference dough without the modified protein. The stretchabilities of the doughs were compared to each other. The stretchability was measured with extensiongraph.

The reference dough contained 300 g wheat flour and 2 g salt dissolved into an amount of water, and 212 ml of water. The test dough contained 300 g wheat flour and 2 g salt dissolved into an amount of water, and 211 ml of water and 4.5 g modified whey protein. The amount of the modified whey protein was 1.5% of the weight of the flours.

The doughs were prepared according to the instructions for the test sample. The problem during the preparation of the reference dough was the sticking of the dough to the rolling pin. Because of this some extra flour had to be used on the surface of the dough ball. Similar amount of flour was added also onto the surface of the test dough ball. During the assays difference between the dough balls were detected. The reference dough was more soft and stickier and harder to handle compared to the test dough, which was more elastic and less sticky.

The key figures of the extensiongraph are shown in the table below.

The Key Figures of the Extensiongraph for Test and Reference Doughs

The test dough contained 1.5% modified whey protein and 0.7% salt of the weight of the flour, and the reference dough contained 0.7% salt of the weight of the flour.

| | KEY FIGURE avg | | | | | |
|---|---|---|---|---|---|---|
| | TEST DOUGH | | | REFERENCE DOUGH | | |
| Leavening | 45 | 90 | 135 | 45 | 90 | 135 |
| time (min) | | | | | | |
| Stretch- | 205 | 171.5 | 178 | 241 | 205 | 178 |
| ability A | | | | | | |
| (mm) | | | | | | |
| Stretch | 380 | 570 | 600 | 305 | 472.5 | 515 |
| resis- | | | | | | |
| tance B | | | | | | |
| (BU) | | | | | | |
| Area (cm²) | 98.3 | 118.9 | 107.5 | 82.7 | 107.5 | 103.8 |
| B/A | 1.85 | 3.32 | 3.37 | 1.27 | 2.30 | 2.89 |

| | | |
|---|---|---|
| Sensory | Dough is elastic | Dough is soft |
| evaluation | and short | and stretchy |

Based on the results of the extensiongraph it is noticed that there are substantial differences between the doughs. The stretchability of the test dough was lower than the reference dough and the stretch resistance and the area were higher. The key figure B/A of the test dough was higher than the reference dough. The test dough was also in sensory evaluation more elastic and shorter as well as stiffer than the reference dough.

Based on these results it can be said that the modified whey protein had clearly a strengthening effect on the dough. The test dough containing 1.5% modified whey protein was more elastic, stronger and stiffer. The shapes of the extensiongraph anticipate a good volume potential for the bread.

This invention has been described with an emphasis upon some of the preferred embodiments and applications. However, it will be apparent for those skilled in the art that variations in the preferred embodiments can be prepared and used e.g. for other protein-containing products and food products. The invention can be practiced otherwise than as specifically described herein within the scope of the following claims.

1. A method for strengthening the structure of a protein-containing food product during a pasteurization heat treatment of said product by forming disulfide bonds between the proteins to form a protein space network, characterized in that the method comprises
adding modified protein to said product before said heat treatment, which protein is modified by cleaving at least one disulfide bond originally present in said protein to obtain free sulfhydryl groups, and
heating said product for 15 minutes or less to cause an interchange reaction by said free sulfhydryl groups to form said structure strengthening disulfide bridges between proteins.

2. The method of claim 1, characterized in that said heating time is 15 seconds to 14 minutes, preferably 1-10 minutes, more preferably 1-3 minutes.

3. The method of claim 1 or 2, characterized in that said heating temperature is 70-85° C., preferably 70-80° C., more preferably 72-75° C.

4. The method of any of the preceding claims, characterized in that said protein has been modified by contacting it with sulfite ion forming reagent, such as alkali metal or earth alkali metal sulfite, hydrogen sulfite or metabisulfite or combinations thereof, to sulfonate said protein.

5. The method of any of the preceding claims, characterized in that the amount of free sulfhydryl groups in the total protein of the product before the interchange modification is 0.5-60 μmol/g protein, preferably 5-20 μmol/g protein.

6. The method of any of the preceding claims, characterized in that said modified protein comprises whey protein or soy protein.

7. The method of any of the preceding claims, characterized in that said food product is yoghurt, pudding, spread, other milk product, dough, animal fodder or pet food.

8. A method for preparing a protein-containing food product having protective functional properties, characterized in that the method comprises
adding modified protein to said product, which protein is modified by cleaving at least one disulfide bond originally present in said protein to obtain free sulfhydryl groups, and
heating said product for 15 minutes or less to cause an interchange reaction by said free sulfhydryl groups to further cleave other disulfide bridges between proteins to obtain free sulfhydryl groups providing said functional properties.

9. The method of claim 8, characterized in that said heating time is 15 seconds to 14 minutes, preferably 1-10 minutes, more preferably 1-3 minutes.

10. The method of claim 8 or 9, characterized in that said heating temperature is 70-85° C., preferably 70-80° C., more preferably 72-75° C.

11. A protein-containing food product comprising a protein space network strengthening the structure of said product, which network is formed in a pasteurization heat treatment by disulfide bonds between proteins, characterized in that said protein network has been created by adding modified protein to the product before said heat treatment, which protein is modified by cleaving at least one disulfide bond originally present in said protein to obtain free sulfhydryl groups which have formed said structure strengthening disulfide bonds in an interchange reaction during a heating of 15 minutes or less.

12. The protein-containing product of claim 11, characterized in that said heating time is 15 seconds to 14 minutes, preferably 1-10 minutes, more preferably 1-3 minutes.

13. The protein-containing product of claim 11 or 12, characterized in that said heating temperature is 70-85° C., preferably 70-80° C., more preferably 72-75° C.

14. The protein-containing product of any of the claims 11-13, characterized in that said protein has been modified by contacting it with sulfite ion forming reagent, such as alkali metal or earth alkali metal sulfite, hydrogen sulfite or metabisulfite or combinations thereof, to sulfonate said protein.

15. The protein-containing product of any of the claims 11-14, characterized in that the amount of free sulfhydryl groups in the total protein of the product before the interchange modification is 0.5-60 μmol/g protein.

16. The protein-containing product of any of the claims 11-15, characterized in that said modified protein comprises whey protein or soy protein.

17. The protein-containing product of any of the claims 11-16, characterized in that said food product is yoghurt, pudding, spread, other milk product, dough, animal fodder or pet food.

18. A protein-containing food product having protective functional properties, characterized in that said product comprises free sulfhydryl groups created by adding modified protein to the product before pasteurization heat treatment, which protein is modified by cleaving at least one disulfide bond originally present in said protein, to obtain free sulfhydryl groups to further cleave other disulfide bonds between proteins during a heating of 15 minutes or less to obtain free sulfhydryl groups providing said functional properties.

19. The protein-containing product of claim 11, characterized in that said heating time is 15 seconds to 14 minutes, preferably 1-10 minutes, more preferably 1-3 minutes.

20. The protein-containing product of claim 11 or 12, characterized in that said heating temperature is 70-85° C., preferably 70-80° C., more preferably 72-75° C.
